(19) United States
(12) Patent Application Publication
(10) Pub. No.: US 2022/0262245 A1
(43) Pub. Date: Aug. 18, 2022

(54) APPARATUS AND METHOD FOR GENERATING TRAFFIC SIGNAL PHASE INFORMATION SERVICE MESSAGE

(71) Applicant: Ways1 Inc., Gyeonggi-do (KR)

(72) Inventor: Jae Hee Kim, Gyeonggi-do (KR)

(21) Appl. No.: 17/646,101

(22) Filed: Dec. 27, 2021

(30) Foreign Application Priority Data
Feb. 18, 2021 (KR) 10-2021-0022090

(51) Int. Cl. G08G 1/081; G08G 1/07; G08G 1/01; G08G 1/056; G01C 21/32; G01C 21/00

(52) U.S. Cl. CPC G08G 1/081; G08G 1/075; G08G 1/0145; G01C 21/3807; G08G 1/056; G01C 21/32; G08G 1/0116

(57) ABSTRACT

Disclosed are an apparatus and method for generating a traffic signal phase information service message. The apparatus includes a precise road map storage unit configured to store a precise road map and a message generation unit configured to generate a MAP message and a Signal Phase and Timing (SPaT) message for a real-time traffic signal phase information service using the precise road map and traffic signal status information.

### CROSS-REFERENCE TO RELATED APPLICATION

This application claims priority to and the benefit of Korean Patent Application No. 10-2021-0022090, filed on Feb. 18, 2021, the disclosure of which is incorporated herein by reference in its entirety.

### BACKGROUND

### 1. Field of the Invention

The present invention relates to an apparatus and method for generating a message for a traffic signal phase information service, and more particularly, to an apparatus and method for generating a traffic signal phase information service message, the apparatus and method being capable of generating a Signal Phase and Timing (SPaT) message and a MAP message for a real-time traffic signal phase information service using a precise road map and traffic signal status information for each intersection.

### 2. Discussion of Related Art

In general, autonomous vehicles collect vehicle operation support information to understand surrounding traffic conditions.

Roadside infrastructure equipment collects traffic signal status information from traffic signal controllers according to a traffic signal controller standard. The traffic signal controller standard is defined as providing a traffic light status and signal display contents (an output type) for each intersection entry direction (a direction code according to a map matching scheme) along with time information. In addition, roadside infrastructure equipment provides traffic signal information of an intersection to autonomous vehicles scheduled to pass through the intersection through wireless communication in the format of a Signal Phase and Timing (SPaT) message and a MAP message of SAE J2735.

In particular, Local Dynamic Map (LDM) among roadside infrastructure equipment connects, stores, and manages standardized vehicle operation support information for autonomous cooperative driving from a traffic signal controller, and also collects various kinds of real-time information of road infrastructure, processes information for V2X service according to SAE J2735 standard using a precise map, and provides the processed information.

However, in the conventional LDM, it was difficult to recognize which route a specific traffic signal status to be transmitted corresponds to among several routes passing through a corresponding intersection, and also it was difficult to match an expression method of information received from a traffic signal controller and an expression method of a message output according to SAE J2735 because the expression methods are different. Furthermore, when it is necessary to service a large area including many traffic signal intersections, there is a problem in that manual matching takes a great deal of time and money.

The background technology of the present invention is disclosed in Korean Patent Publication No. 10-2020-0134136, entitled “PATH PROVIDING DEVICE AND PATH PROVIDING METHOD THEREOF” and published on Dec. 1, 2020.

### SUMMARY OF THE INVENTION

The present invention is designed to solve the above problems, and an object according to an aspect of the present invention is to provide an apparatus and method of generating a traffic signal phase information service message, the apparatus and method being capable of generating a Signal Phase and Timing (SPaT) message and a MAP message for a real-time traffic signal phase information service using a precise road map and traffic signal status information for each intersection.

According to an aspect of the present invention, there is provided an apparatus for generating a traffic signal phase information service message, the apparatus including a precise road map storage unit configured to store a precise road map and a message generation unit configured to generate a MAP message and a Signal Phase and Timing (SPaT) message for a real-time traffic signal phase information service using the precise road map and traffic signal status information.

The message generation unit may include a MAP message generation unit configured to generate lane link groups by grouping lane links of the precise road map corresponding to an entry to and an exit from an intersection having a traffic light and generate a MAP message by assigning signal group numbers to the lane link groups, and an SPaT message generation unit configured to generate an SPaT message by combining direction information and output information of the traffic signal status information and matching the combined information to one of the signal group numbers.

The MAP message generation unit may include a road node extraction unit configured to extract a road node of an intersection in a navigation road map, an angle calculation unit configured to extract a road link of the navigation road map connected to the road node extracted by the road node extraction unit and calculate an intersection entry direction angle and an intersection exit direction angle of the extracted road link, and a grouping unit configured to group the lane links corresponding to an entry to and exit from the intersection to generate the lane link group on the basis of the road node extracted by the road node extraction unit and configured to generate the MAP message by sequentially assigning the signal group numbers to the lane link groups.

The road node extraction unit may extract the road node on the basis of attribute information capable of distinguishing an intersection having a traffic light among attribute information of the road node.

The grouping unit may extract internal lane links of the intersection included in the road node extracted by the road node extraction unit, extract an intersection entry lane link and an intersection exit lane link connected to the internal lane links of the intersection, detect an intersection entry road link and an intersection exit road link including the intersection entry lane link and the intersection exit lane link, and then group lane links having the same intersection entry road link and the same intersection exit road link to generate the lane link groups.

The grouping unit may generate an entry lane link for entering the intersection or an exit lane link for exiting the intersection as GenericLane entities of the MAP message, input the signal group numbers while using a connection relationship between the GenericLane entities to generate ConnectsToList, and store the intersection entry direction angle and the intersection exit direction angle of the road link.

The SPaT message generation unit may include a lane link detection unit configured to specify a road link designated by a direction code of the traffic signal status information using the direction code and the intersection entry direction angle of the road link and extract a lane link included in the specified road link and a signal group detection unit configured to select and access an exit road link for each entry road link according to an output type of the traffic signal status information and configured to match lane links included in the accessed entry road link and the exit road link to the signal group numbers along with the direction code, the output type, and a traffic light status.

The lane link detection unit may compare a relative angle between the intersection entry road link and the intersection exit road link to a preset setting range and select the intersection exit road link according to a result of the comparison.

The SPaT message generation unit may further include a signal group definition unit configured to store a signal group detected by the signal group detection unit in signalGroup of MovementState data frame of the SPaT message and convert the traffic light status into a value of eventState of MovementEvent corresponding to MovementPhaseState definition.

MovementPhaseState may classify the relationship between the entry road link and the exit road link into going straight and turning left, going straight and making an unprotected left turn, and turning right.

The output type may include at least one of going straight, turning left, and walking.

The traffic light status may include at least one of turn off, red light on, yellow light on, green light on, red flashing, yellow flashing, and green flashing.

The message generation unit may include a communication unit configured to deliver the MAP message and the SPaT message to a vehicle.

According to another aspect of the present invention, there is provided a method of generating a traffic signal phase information service message, the method including an operation of collecting traffic signal status information, an operation of generating lane link groups by grouping lane links of a precise road map according to an entry to and an exit from an intersection having a traffic light, and generating a MAP message by assigning signal group numbers to the lane link groups and an operation of generating a Signal Phase and Timing (SPaT) message by combining direction information and output information of the traffic signal status information and matching the combined information to one of the signal group numbers.

The operation of generating a MAP message may include an operation of extracting a road node of an intersection in a navigation road map, an operation of extracting a road link of the navigation road map connected to the extracted road node and calculating an intersection entry direction angle and an intersection exit direction angle of the extracted road link, and an operation of grouping the lane links corresponding to an entry to and exit from the intersection to generate the lane link groups on the basis of the extracted road node and generating the MAP message by sequentially assigning the signal group numbers to the lane link groups.

The operation of extracting a road node may include an operation of extracting a road node on the basis of attribute information capable of distinguishing an intersection having a traffic light among attribute information of the road node.

The operation of generating the MAP message by sequentially assigning the signal group numbers to the lane link groups may include an operation of extracting internal lane links of the intersection included in the extracted road node, extracting an intersection entry lane link and an intersection exit lane link connected to the internal lane links of the intersection, detecting an intersection entry road link and an intersection exit road link including the intersection entry lane link and the intersection exit lane link, and then grouping lane links having the same intersection entry road link and the same intersection exit road link to generate the lane link groups.

The operation of generating the MAP message by sequentially assigning the signal group numbers to the lane link groups may include an operation of generating an entry lane link for entering the intersection or an exit lane link for exiting the intersection as GenericLane entities of the MAP message, inputting the signal group numbers while using a connection relationship between the GenericLane entities to generate ConnectsToList, and storing the intersection entry direction angle and the intersection exit direction angle of the road link.

The operation of generating an SPaT message may include an operation of specifying a road link designated by a direction code of the traffic signal status information using the direction code and the intersection entry direction angle of the road link and extracting a lane link included in the specified road link and an operation of selecting and accessing an exit road link for each entry road link according to an output type of the traffic signal status information and matching lane links included in the accessed entry road link and the exit road link to the signal group numbers along with the direction code, the output type, and a traffic light status to generate a signal group.

The operation of extracting a lane link included in the specified road link may include an operation of comparing a relative angle between the intersection entry road link and the intersection exit road link to a preset setting range and selecting the intersection exit road link according to a result of the comparison.

The operation of generating an SPaT message may further include an operation of storing the signal group in signalGroup of MovementState data frame of the SPaT message and converting the traffic light status into a value of eventState of MovementEvent corresponding to MovementPhaseState definition.

MovementPhaseState may classify the relationship between the entry road link and the exit road link into going straight and turning left, going straight and making an unprotected left turn, and turning right.

The output type may include at least one of going straight, turning left, and walking.

The traffic light status may include at least one of turn off, red light on, yellow light on, green light on, red flashing, yellow flashing, and green flashing.

The method may further include delivering the MAP message and the SPaT message to a vehicle.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of an apparatus for generating a traffic signal phase information service message according to an embodiment of the present invention;

FIGS. 2 to 4 are diagrams showing signal status information provision formats according to an embodiment of the present invention;

FIG. 5 is a block diagram of a message processing unit according to an embodiment of the present invention;

FIG. 6 is an exemplary diagram of a precise road map of an intersection according to an embodiment of the present invention;

FIG. 7 is a diagram showing a signal status information matching method according to an embodiment of the present invention;

FIG. 8 is a diagram showing an example of direction determination based on a relative angle between an entry road link and an exit road link according to an embodiment of the present invention;

FIG. 9 is a diagram showing an example of defining Movement PhaseState corresponding to a direction code according to an embodiment of the present invention; and

FIG. 10 is a flowchart of a method of generating a traffic signal phase information service message according to an embodiment of the present invention.

### DETAILED DESCRIPTION OF EXEMPLARY EMBODIMENTS

As is traditional in the corresponding field, some exemplary embodiments may be illustrated in the drawings in terms of functional blocks, units, and/or modules. Those of ordinary skill in the art will appreciate that these block, units, and/or modules are physically implemented by electronic (or optical) circuits such as logic circuits, discrete components, processors, hard-wired circuits, memory elements, wiring connections, and the like. When the blocks, units, and/or modules are implemented by processors or similar hardware, they may be programmed and controlled using software (e.g., code) to perform various functions discussed herein. Alternatively, each block, unit, and/or module may be implemented by dedicated hardware or as a combination of dedicated hardware to perform some functions and a processor (e.g., one or more programmed processors and associated circuitry) to perform other functions. Each block, unit, and/or module of some exemplary embodiments may be physically separated into two or more interacting and discrete blocks, units, and/or modules without departing from the scope of the inventive concept. Further, blocks, units, and/or module of some exemplary embodiments may be physically combined into more complex blocks, units, and/or modules without departing from the scope of the inventive concept.

Hereinafter, an apparatus and method for generating a traffic signal phase information service message according to an embodiment of the present invention will be described in detail with reference to the accompanying drawings. In the drawings, thicknesses of lines or sizes of elements may be exaggerated for clarity and convenience. Also, the following terms are defined considering functions of the present invention and may be differently defined depending on a user, the intent of an operator, or a custom. Therefore, the terms should be defined based on overall content of the specification.

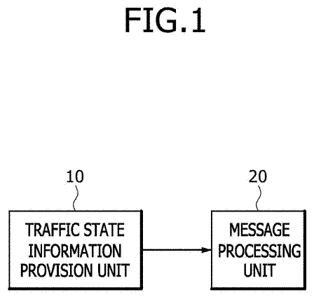

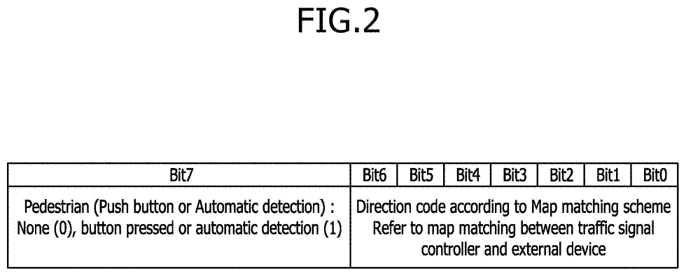

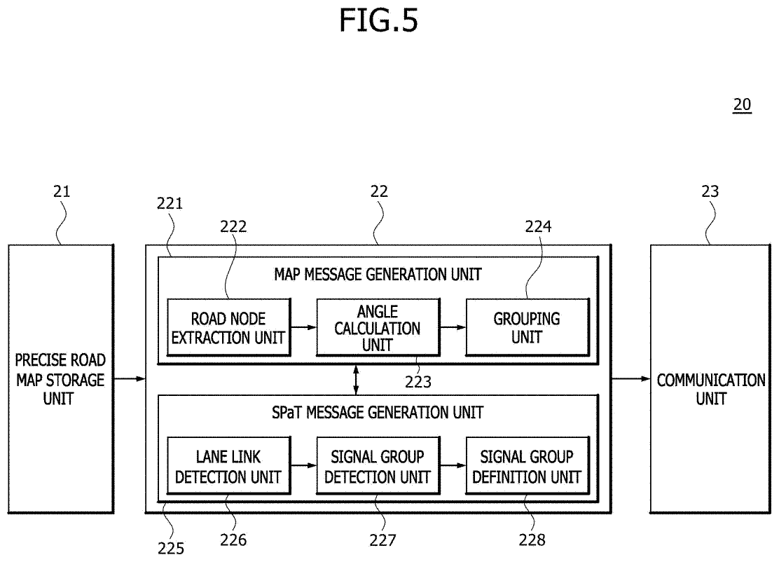

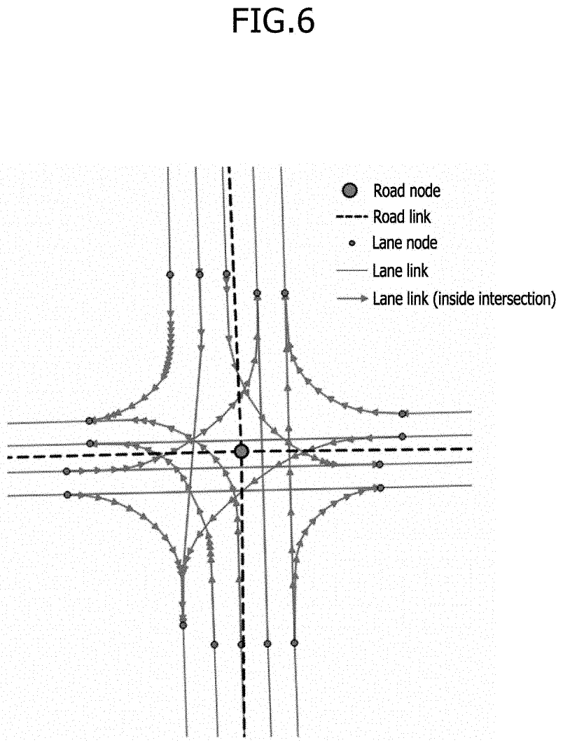

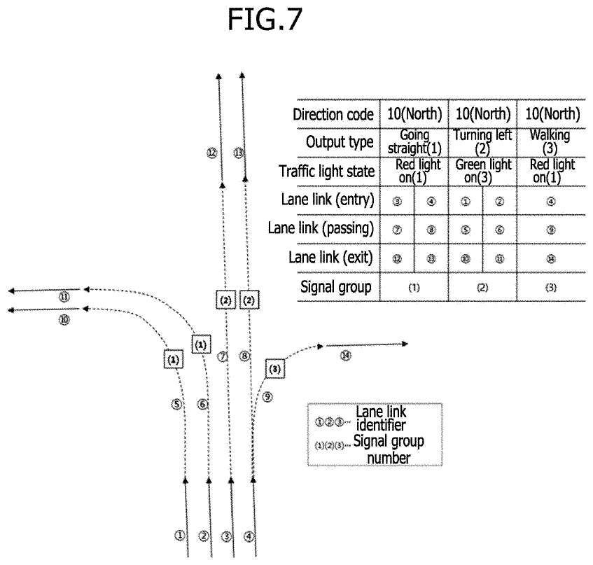

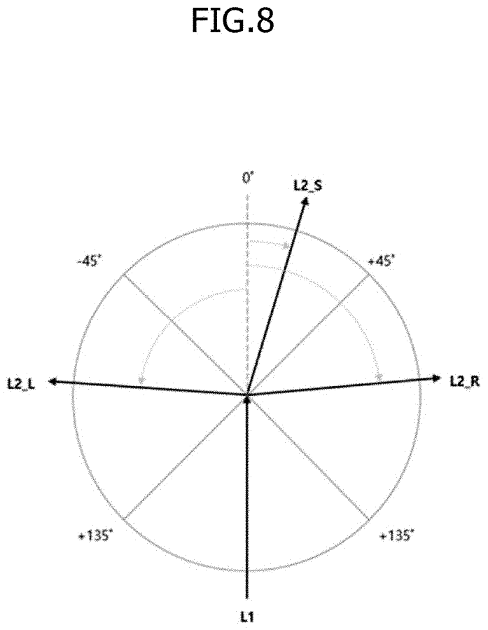

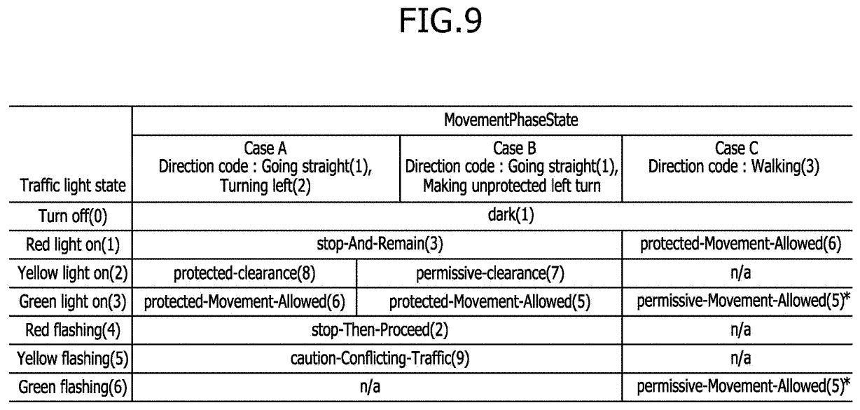

FIG. 1 is a block diagram of an apparatus for generating a traffic signal phase information service message according to an embodiment of the present invention. FIGS. 2 to 4 are diagrams showing signal status information provision formats according to an embodiment of the present invention. FIG. 5 is a block diagram of a message processing unit according to an embodiment of the present invention. FIG. 6 is an exemplary diagram of a precise road map of an intersection according to an embodiment of the present invention. FIG. 7 is a diagram showing a signal status information matching method according to an embodiment of the present invention. FIG. 8 is a diagram showing an example of direction determination based on a relative angle between an entry road link and an exit road link according to an embodiment of the present invention. FIG. 9 is a diagram showing an example of defining Movement PhaseState corresponding to a direction code according to an embodiment of the present invention.

Referring to FIG. 1, the apparatus for generating a traffic signal phase information service message according to an embodiment of the present invention includes a traffic signal status information provision unit 10 and a message processing unit 20.

The traffic signal status information provision unit 10 collects and delivers traffic signal status information to the message processing unit 20 through various wired and wireless communication networks. In this case, the traffic signal status information provision unit 10 may deliver the information to the message processing unit 20 according to a preset traffic signal information provision format.

The traffic signal status information provision unit 10 may include a traffic signal controller. The traffic signal controller may be installed on a roadside of a road. The traffic signal controller collects traffic signal status information in a preset traffic signal controller standard and delivers the collected traffic signal status information to the message processing unit 20 through the wired and wireless communication networks.

The traffic signal status information is delivered according to the preset traffic signal status information provision format. As an example, the traffic signal status information provision format may be a traffic signal controller provision format for the National Police Agency. The traffic signal status information may include direction information and output information.

Referring to FIG. 2, the direction information may include walking and a direction code corresponding to a direction of a vehicle entering an intersection, that is, a direction code according to a map matching direction.

The walking indicates a walking signal within an intersection traffic signal system.

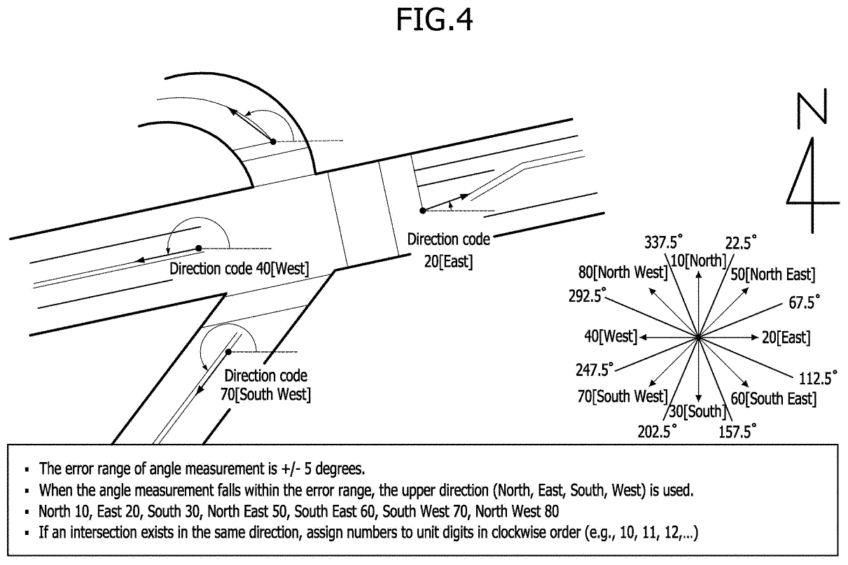

As shown in FIG. 4, the direction code may be designated as a number for each direction in which a vehicle enters the intersection.

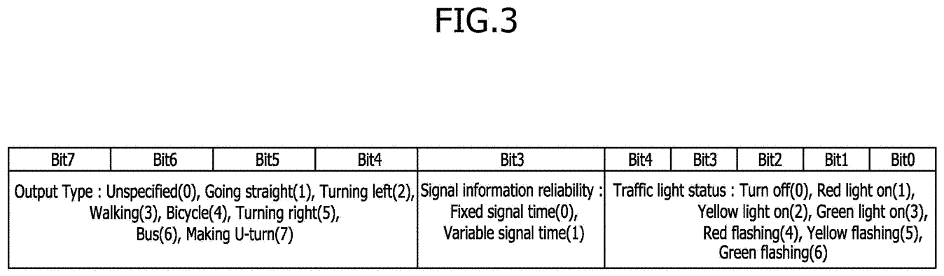

Referring to FIG. 3, the output information includes an output type, time information reliability, and a traffic light status.

The output type is signal display contents for each direction of entering the intersection and is designated by a number. The output type may include unspecified, going straight, turning left, walking, bicycle, turning right, bus, and making a U-turn.

The time information reliability may include fixed signal time and variable signal time, each of which is designated by a number.

The traffic light status may include turn off, red light on, yellow light on, green light on, red flashing, yellow flashing, and green flashing, each of which is designated by a number.

The message processing unit 20 automatically generates a MAP message and a Signal Phase and Timing (SPaT) message for a real-time traffic signal phase information service using a precise road map and traffic signal status information for each intersection.

The MAP message and the SPaT message are real-time traffic signal phase information service messages for autonomous vehicles or Cooperative Intelligent Transport Systems (C-ITS) vehicles.

In general, intelligent transportation systems provide efficient and safe transportation services by applying information and communication technologies such as electronic control and communication devices to transportation means such as automobiles, buses, and trains and to transportation facilities installed around roads such as traffic lights and electric signs. For this, vehicle-to-everything (V2X) communication technology may be applied. V2X communication technology, which is a communication technology between a vehicle and a vehicle or between a vehicle and a peripheral device, is applicable to an intelligent transportation system.

Accordingly, the above-described MAP message and SPaT message may be delivered to nearby autonomous vehicles, C-ITS vehicles, connected cars, etc. on the basis of the V2X communication technology. An autonomous vehicle or a C-ITS vehicle can use the MAP message and the SPaT message for vehicle driving.

The SAE J2735 standard includes a message layer and defines a set of Dedicated Short Range Communication (DSRC) messages transmitted and received between vehicles or between vehicles and infrastructure.

The MAP message and the SPaT message are delivered according to the SAE J2735 standard, which defines, through the MAP message, the entry and exit lanes of an intersection of which a traffic signal information service is to be provided and provides, through the SPaT message, information for a route of which traffic is controlled by traffic signals.

The message processing unit 20 generates the MAP message and the SPaT message according to the SAE J2735 standard as described above and transmits the messages to autonomous vehicles or C-ITS vehicles.

The message processing unit 20 may be installed in the existing roadside infrastructure equipment, but the present invention is not limited thereto.

Referring to FIG. 5, the message processing unit 20 includes a precise road map storage unit 21 and a message generation unit 22.

The precise road map storage unit 21 stores precise road maps. The precise road maps may be, for example, precise road maps of the Korea National Geographic Information Institute, but the present invention is not limited thereto.

The precise road maps are maps obtained by modeling road objects such as lanes, stop lines, road signs, and road facilities in three dimensions and producing the shape and the attachment information as spatial data. The precise road maps include a network that expresses the driving routes of vehicles by lane in a node-link structure.

In this embodiment, a driving route node A1_NODE and a driving route link A2_LINK of a precise road map are expressed as a lane node and a lane link, respectively.

In addition, the nodes and links of a navigation road map used for general navigation are marked as road nodes and road links, respectively.

The lane link of the precise road map has an inclusive relationship that matches an actual road configuration, and information on the road nodes and the road links is input.

Referring to FIG. 6, lane link entities represented by solid lines refer to the lanes of actual roads connected between intersections and thus have information referring to road link entities represented by dotted lines at the same locations. Also, lane link entities represented by arrows refer to virtual driving routes inside intersections and thus have information referring to road node entities in the center.

The message generation unit 22 generates a MAP message and an SPaT message for a real-time traffic signal phase information service using a precise road map and traffic signal status information for each intersection.

The message generation unit 22 includes a map message generation unit 221 and an SPaT message generation unit 225.

The map message generation unit 221 generates a lane link group by grouping lane links on a precise road map according to an entry to and an exit from an intersection having a traffic light and generates a map message by assigning a signal group number to each lane link group.

The map message generation unit 221 includes a road node extraction unit 222, an angle calculation unit 223, and a grouping unit 224.

The road node extraction unit 222 extracts a road node of an intersection from a navigation road map.

That is, the road node extraction unit 222 extracts a road node expressing an intersection point from the entire area of the map. In particular, the road node extraction unit 222 extracts a road node corresponding to a traffic signal intersection on the basis of an attribute for distinguishing an intersection having a traffic light installed thereon among attribute information of the road node, that is, on the basis of whether there is a traffic signal intersection.

The angle calculation unit 223 extracts a road link of the navigation road map connected to the road node extracted by the road node extraction unit 222 and calculates an intersection entry direction angle and an intersection exit direction angle of the extracted road link.

The grouping unit 224 generates lane link groups by grouping lane links corresponding to an entry to and an exit from the intersection on the basis of the road node extracted by the road node extraction unit 222 and generates a MAP message by sequentially assigning signal group numbers to the lane link groups.

That is, the grouping unit 224 extracts internal lane links of the intersection included in the road node and extracts an intersection exit lane link and an intersection entry lane link connected to the extracted internal lane links of the intersection. The grouping unit 224 detects an intersection entry road link and an intersection exit road link including the intersection entry lane link and the intersection exit lane link. The grouping unit 224 groups lane links having the same intersection entry road link and the same intersection exit road link. Subsequently, the grouping unit 224 sequentially assigns signal group numbers to the groups and records the numbers to the corresponding lane links as an attribute.

In addition, the grouping unit 224 extracts intersection exit lane links or intersection entry lane links connected to the internal lane links of the intersection and generates the intersection exit lane links or intersection entry lane links connected to the internal lane links of the intersection as GenericLane entities of the MAP message.

Subsequently, the grouping unit 224 inputs the signal group numbers while using the connection relationship between the GenericLane entities to generate ConnectsToList, and separately stores an intersection entry direction angle and an intersection exit direction angle of the road link.

The SPaT message generation unit 225 generates an SPaT message by combining output information and direction information of the traffic signal status information and matching the combined information to any one of the signal group numbers.

The SPaT message generation unit 225 includes a lane link detection unit 226, a signal group detection unit 227, and a signal group definition unit 228.

The lane link detection unit 226 specifies a road link designated by a direction code of the traffic signal status information using the direction code and the intersection entry direction angle of the road link and extracts a lane link included in the specified road link.

For example, the lane link detection unit 226 compares the direction code (e.g., 10=north, 20=east) of the traffic signal status information to the intersection entry angle, specifies an exit road link designated by the direction code, and extracts a lane link included in the exit road link.

Referring to FIG. 7, the lane links may correspond to \textcircled{1}, \textcircled{2}, \textcircled{3}, and \textcircled{4}.

The signal group detection unit 227 selects and accesses an entry road link for each entry road link according to the output type of the traffic signal status information and matches the lane links included in the exit road link and the accessed entry road link for each entry road link to the signal group numbers along with the direction code, the output type, and a traffic light status.

Referring to FIGS. 7 and 8, the signal group detection unit 227 selects an exit road link corresponding to an output type value (1=going straight, 2=turning left, and 3=walking) among entry road links that exit the intersection, which are connected to entry road links that enter the intersection.

In this case, the signal group detection unit 227 may compare the relative angle between the entry road link and the exit road link to a preset setting range and select the exit road link according to the comparison result.

For example, when the output type value is 1 (going straight), the signal group detection unit 227 selects an exit road link L2_S with an angle relative to an entry road link L1 being −45° to +45°.

When the output type value is 2 (turning left), the signal group detection unit 227 selects an exit road link L2_L with an angle relative to the entry road link L1 being −135° to −45°.

When the output type value is 3 (walking; turning right), the signal group detection unit 227 selects an exit road link L2_R with an angle relative to the entry road link L1 being +45° to +135°.

Here, the determination of going straight and turning left/right is that of a navigation route guide generation algorithm, and an angle set in the range may be changed by tuning.

Accordingly, as shown in FIG. 7, when the direction code value is 10 (north) and the output type value is 1 (going straight), the entry road link L1 and the exit road link L2_S are matched, and the combination of lane links \textcircled{3}, \textcircled{7}, and \textcircled{12}, and the combination of lane links \textcircled{4}, \textcircled{8}, and \textcircled{13}, each including the entry road link L1 and the exit road link L2_S, can be found and may correspond to the signal group number (1) assigned in the above process.

Also, when the direction code value is 10 (north) and the output type value is 2 (turning left), the entry road link L1 and the exit road link L2_L are matched, and the combination of lane links \textcircled{1}, \textcircled{5}, and \textcircled{10}, and the combination of lane links \textcircled{2}, \textcircled{6}, and \textcircled{11}, each including the entry road link L1 and the exit road link L2_L, can be found and may correspond to the signal group number (2) assigned in the above process.

Also, when the direction code value is 10 (north) and the output type value is 3 (walking), the entry road link L1 and the exit road link L2_R are matched, and the combination of lane links \textcircled{4}, \textcircled{9}, and \textcircled{14} can be found and may correspond to the signal group number (3) assigned in the above process.

The signal group definition unit 228 stores signal groups detected by the signal group detection unit 227 in signalGroup of MovementState data frame of an SPaT message and converts the traffic light status into a value of eventState of MovementEvent corresponding to the definition of MovementPhaseState. Here, MovementPhaseState classifies the relationship between the entry road link and the exit road link into going straight and turning left, going straight and making an unprotected left turn, and walking.

Referring to FIG. 9, in the case of a signal group in which the relationship of entry-exit road links in map data is input as an unprotected left turn, the signal group definition unit 228 uses the correspondence of Case B according to a traffic signal status of an input in which the output type value is (1) (going straight) and uses the correspondence of Case C in case of a right turn.

The communication unit 23 delivers the MAP data and the SPaT message generated as described above to nearby autonomous vehicles, C-ITS vehicles, connected cars, and the like. In this case, the autonomous vehicle, the C-ITS vehicle, and the connected car receive the MAP message and the SPaT message through the communication unit 23 and use the MAP message and the SPaT message for vehicle driving.

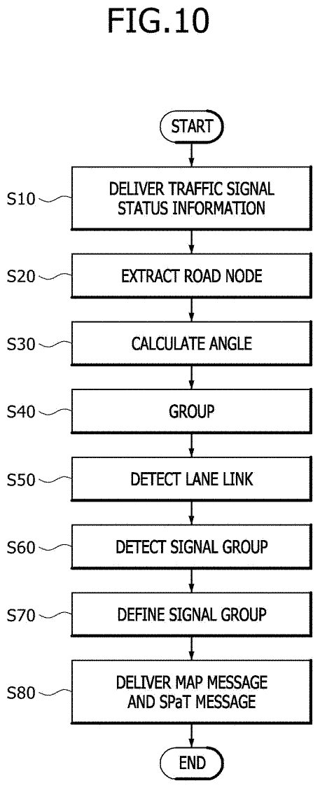

Hereinafter, a method of generating a traffic signal phase information service message according to an embodiment of the present invention will be described in detail with reference to FIG. 10.

FIG. 10 is a flowchart of a method of generating a traffic signal phase information service message according to an embodiment of the present invention.

Referring to FIG. 10, first, a traffic signal status information provision unit 10 collects traffic signal status information and delivers the traffic signal status information to a message processing unit 20 according to a preset traffic signal information provision format (S10).

Here, the traffic signal status information provision format may be a traffic signal controller provision format for the Korean National Police Agency. The traffic signal status information may include direction information and output information.

A road node extraction unit 222 extracts a road node expressing an intersection point from the entire area of a map (S20). In this case, the road node extraction unit 222 extracts a road node corresponding to a traffic signal intersection when there is an attribute for distinguishing an intersection having a traffic light installed thereon among attribute information of the road node, that is, when there is a traffic signal intersection.

An angle calculation unit 223 extracts a road link of a navigation road map connected to the road node extracted by the road node extraction unit 222 and calculates an intersection entry direction angle and an intersection exit direction angle of the extracted road link (S30).

A grouping unit 224 extracts internal lane links of the intersection included in the road node and extracts an intersection exit lane link and an intersection entry lane link connected to the extracted internal lane links of the intersection. Subsequently, the grouping unit 224 detects an intersection entry road link and an intersection exit road link including the intersection entry lane link and the intersection exit lane link, and groups road links having the same intersection entry road link and the intersection exit road link (S40). Subsequently, the grouping unit 224 sequentially assigns signal group numbers to the groups and records the numbers to the corresponding lane links as an attribute.

In this case, the grouping unit 224 generates the intersection exit lane links or intersection entry lane links connected to the internal lane links of the intersection as GenericLane entities of the MAP message, and the grouping unit 224 inputs the signal group numbers while using the connection relationship between the GenericLane entities to generate ConnectsToList and separately stores an intersection entry direction angle and an intersection exit direction angle of the road link.

A lane link detection unit 226 specifies a road link designated by a direction code of the traffic signal status information using the direction code and the intersection entry direction angle of the road link and extracts a lane link included in the specified road link (S50).

A signal group detection unit 227 selects and accesses an entry road link for each entry road link according to the output type of the traffic signal status information and matches the lane links included in the exit road link and the accessed entry road link for each entry road link to the signal group numbers along with the direction code, the output type, and a traffic light status to detect a signal group (S60).

Subsequently, a signal group definition unit 228 defines the signal group detected by the signal group detection unit 227 (S70). That is, the signal group definition unit 228 stores the signal group in signalGroup of MovementState data frame of an SPaT message and converts the traffic light status into a value of eventState of MovementEvent corresponding to the MovementPhaseState definition.

Finally, a communication unit 23 delivers the MAP message and the SPaT message generated as described above to a vehicle (S80). Accordingly, a nearby autonomous vehicle, c-ITS vehicle, connected car, and the like receive the MAP message and the SPaT message through the communication unit 23 and use the MAP message and the SPaT message for vehicle driving.

As described above, the apparatus and method for generating a traffic signal phase information service message according to an embodiment of the present invention automatically generate a MAP message and an SPaT message for a real-time traffic signal phase information service by using a precise road map and traffic signal status information for each intersection.

Also, the apparatus and method for generating a traffic signal phase information service message according to an embodiment of the present invention can minimize the time and cost required for manual matching to generate the traffic signal phase information service message.

According to an aspect of the present invention, the apparatus and method for generating a traffic signal phase information service message automatically generate a MAP message and a Signal Phase and Timing (SPaT) message for a real-time traffic signal phase information service by using a precise road map and traffic signal status information for each intersection.

According to another aspect of the present invention, the apparatus and method for generating a traffic signal phase information service message can minimize the time and cost required for manual matching to generate a traffic signal phase information service message.

The implementations described herein may be implemented in, for example, a method or a process, an apparatus, a software program, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, smartphones, tablets, computers, mobile phones, portable/personal digital assistants (PDAs), and other devices that facilitate communication of information between end-users.

While the present invention has been described with reference to an embodiment shown in the accompanying drawings, it should be understood by those skilled in the art that this embodiment is merely illustrative of the invention and that various modifications and equivalents may be made without departing from the spirit and scope of the invention. Therefore, the technical scope of the present invention should be defined by the appended claims.

What is claimed is:

1. An apparatus for generating a traffic signal phase information service message, the apparatus comprising:
a precise road map storage unit configured to store a precise road map; and
a message generation unit configured to generate a MAP message and a Signal Phase and Timing (SPaT) message for a real-time traffic signal phase information service using the precise road map and traffic signal status information.

2. The apparatus of claim 1, wherein the message generation unit comprises:
a MAP message generation unit configured to generate lane link groups by grouping lane links of the precise road map corresponding to an entry to and an exit from an intersection having a traffic light and generate a MAP message by assigning signal group numbers to the lane link groups; and
an SPaT message generation unit configured to generate an SPaT message by combining direction information and output information of the traffic signal status information and matching the combined information to one of the signal group numbers.

3. The apparatus of claim 2, wherein the MAP message generation unit comprises:
a road node extraction unit configured to extract a road node of an intersection in a navigation road map;
an angle calculation unit configured to extract a road link of the navigation road map connected to the road node extracted by the road node extraction unit and calculate an intersection entry direction angle and an intersection exit direction angle of the extracted road link; and
a grouping unit configured to group the lane links corresponding to an entry to and exit from the intersection to generate the lane link group on the basis of the road node extracted by the road node extraction unit and configured to generate the MAP message by sequentially assigning the signal group numbers to the lane link groups.

4. The apparatus of claim 3, wherein the road node extraction unit extracts a road node on the basis of attribute information capable of distinguishing an intersection having a traffic light among attribute information of the road node.

5. The apparatus of claim 3, wherein the grouping unit extracts internal lane links of the intersection included in the road node extracted by the road node extraction unit, extracts an intersection entry lane link and an intersection exit lane link connected to the internal lane links of the intersection, detects an intersection entry road link and an intersection exit road link including the intersection entry lane link and the intersection exit lane link, and then groups lane links having the same intersection entry road link and the same intersection exit road link to generate the lane link groups.

6. The apparatus of claim 5, wherein the grouping unit generates an entry lane link for entering the intersection or an exit lane link for exiting the intersection as GenericLane entities of the MAP message, inputs the signal group numbers while using a connection relationship between the GenericLane entities to generate ConnectsToList, and stores the intersection entry direction angle and the intersection exit direction angle of the road link.

7. The apparatus of claim 3, wherein the SPaT message generation unit comprises:
a lane link detection unit configured to specify a road link designated by a direction code of the traffic signal status information using the direction code and the intersection entry direction angle of the road link and extract a lane link included in the specified road link; and
a signal group detection unit configured to select and access an exit road link for each entry road link according to an output type of the traffic signal status information and configured to match lane links included in the accessed entry road link and the exit road link to the signal group numbers along with the direction code, the output type, and a traffic light status.

8. The apparatus of claim 7, wherein the lane link detection unit compares a relative angle between the intersection entry road link and the intersection exit road link to a preset setting range and selects the intersection exit road link according to a result of the comparison.

9. The apparatus of claim 8, wherein the SPaT message generation unit further comprises a signal group definition unit configured to store a signal group detected by the signal group detection unit in signalGroup of MovementState data frame of the SPaT message and convert the traffic light status into a value of eventState of MovementEvent corresponding to MovementPhaseState definition.

10. The apparatus of claim 9, wherein MovementPhaseState classifies the relationship between the entry road link and the exit road link into going straight and turning left, going straight and making an unprotected left turn, and turning right.

11. A method of generating a traffic signal phase information service message, the method comprising operations of:
collecting traffic signal status information;
generating lane link groups by grouping lane links of a precise road map corresponding to an entry to and an exit from an intersection having a traffic light, and generating a MAP message by assigning signal group numbers to the lane link groups; and
generating a Signal Phase and Timing (SPaT) message by combining direction information and output information of the traffic signal status information and matching the combined information to one of the signal group numbers.

12. The method of claim 11, wherein the operation of generating a MAP message comprises operations of:
extracting a road node of an intersection in a navigation road map;
extracting a road link of the navigation road map connected to the extracted road node and calculating an intersection entry direction angle and an intersection exit direction angle of the extracted road link; and
grouping the lane links corresponding to an entry to and exit from the intersection to generate the lane link groups on the basis of the extracted road node and generating the MAP message by sequentially assigning the signal group numbers to the lane link groups.

13. The method of claim 12, wherein the operation of extracting a road node comprises an operation of extracting a road node on the basis of attribute information capable of distinguishing an intersection having a traffic light among attribute information of the road node.

14. The method of claim 12, wherein the operation of generating the MAP message by sequentially assigning the signal group numbers to the lane link groups comprises an operation of extracting internal lane links of the intersection included in the extracted road node, extracting an intersection entry lane link and an intersection exit lane link connected to the internal lane links of the intersection, detecting an intersection entry road link and an intersection exit road link including the intersection entry lane link and the intersection exit lane link, and then grouping lane links having the same intersection entry road link and the same intersection exit road link to generate the lane link groups.

15. The method of claim 14, wherein the operation of generating the MAP message by sequentially assigning the signal group numbers to the lane link groups comprises an operation of generating an entry lane link for entering the intersection or an exit lane link for exiting the intersection as GenericLane entities of the MAP message, inputting the signal group numbers while using a connection relationship between the GenericLane entities to generate ConnectsToList, and storing the intersection entry direction angle and the intersection exit direction angle of the road link.

16. The method of claim 12, wherein the operation of generating an SPaT message comprises operations of:
specifying a road link designated by a direction code of the traffic signal status information using the direction code and the intersection entry direction angle of the road link and extracting a lane link included in the specified road link; and
selecting and accessing an exit road link for each entry road link according to an output type of the traffic signal status information and matching lane links included in the accessed entry road link and the exit road link to the signal group numbers along with the direction code, the output type, and a traffic light status to generate a signal group.

17. The method of claim 16, wherein the operation of extracting a lane link included in the specified road link comprises an operation of comparing a relative angle between the intersection entry road link and the intersection exit road link to a preset setting range and selecting the intersection exit road link according to a result of the comparison.

18. The method of claim 17, wherein the operation of generating an SPaT message further comprises an operation of storing the signal group in signalGroup of MovementState data frame of the SPaT message and converting the traffic light status into a value of eventState of MovementEvent corresponding to MovementPhaseState definition.

19. The method of claim 18, wherein MovementPhaseState classifies the relationship between the entry road link and the exit road link into going straight and turning left, going straight and making an unprotected left turn, and turning right.
